(19) United States
(12) Patent Application Publication
(10) Pub. No.: US 2015/0049672 A1
(43) Pub. Date: Feb. 19, 2015

(54) METHODS AND APPARATUS FOR AVOIDING OR ESCAPING CELL RANGE EXPANSION (CRE) IN A HETEROGENEOUS NETWORK

(71) Applicant: QUALCOMM INCORPORATED, San Diego, CA (US)

(72) Inventors: Xiliang LUO, San Diego, CA (US); Brian Clarke BANISTER, San Diego, CA (US); Shivratna Giri SRINIVASAN, San Diego, CA (US); Keith William SAINTS, San Diego, CA (US); Amir AMINZADEH GOHARI, Poway, CA (US); Wenshu ZHANG, San Diego, CA (US); Timothy Paul PALS, San Diego, CA (US); Ke LIU, San Diego, CA (US); Alexei Yurievitch GOROKHOV, San Diego, CA (US); Amir FARAJIDANA, Sunnyvale, CA (US)

(21) Appl. No.: 14/459,071

(22) Filed: Aug. 13, 2014

Related U.S. Application Data
(60) Provisional application No. 61/865,688, filed on Aug. 14, 2013.

(51) Int. Cl. H04W 40/16; H04W 40/30

(52) U.S. Cl. CPC H04W 40/16; H04W 40/30
USPC 370/328

(57) ABSTRACT

Certain aspects relate to methods and apparatus for avoiding and/or escaping cell range expansion (CRE) in a heterogeneous network (HetNet). A user equipment (UE) may detect the occurrence of one or more conditions while the UE is in a region of cell range expansion (CRE) in which the UE may be handed over from a first cell of a first power class type to a second cell of a second power class type, the second power class type being lower than the first power class type. The UE may take action to stop being served by the second cell or avoid being handed over to the second cell in response to the detection.

### CLAIM OF PRIORITY UNDER 35 U.S.C. §119

The present application for patent claims priority to U.S. Provisional Application No. 61/865,688, entitled “METHODS AND APPARATUS FOR AVOIDING OR ESCAPING CELL RANGE EXPANSION (CRE) IN A HETEROGENEOUS NETWORK”, filed Aug. 14, 2013, and assigned to the assignee hereof and expressly incorporated by reference herein.

### BACKGROUND

1. Field

Certain aspects of the present disclosure generally relate to wireless communications and, more specifically, to methods and apparatus for reducing interference in a heterogeneous network (e.g., avoiding or escaping cell range expansion (CRE) in a heterogeneous network).

2. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may observe interference due to transmissions from one or more neighbor base stations. On the uplink, a transmission from the UE may cause interference to transmissions from one or more other UEs communicating with the one or more neighbor base stations. The interference may degrade performance on both the downlink and uplink.

### SUMMARY

Certain aspects of the present disclosure provide a method for wireless communication by a user equipment (UE). The method generally includes detecting the occurrence of one or more conditions while the UE is in a region of cell range expansion (CRE) in which the UE may be handed over from a first cell of a first power class type to a second cell of a second power class type, wherein the second power class type is lower than the first power class type, and taking action to stop being served by the second cell or avoid being handed over to the second cell in response to the detection.

Certain aspects of the present disclosure provide an apparatus for wireless communications by a user equipment (UE). The apparatus generally includes means for detecting the occurrence of one or more conditions while the UE is in a region of cell range expansion (CRE) in which the UE may be handed over from a first cell of a first power class type to a second cell of a second power class type, wherein the second power class type is lower than the first power class type, and means for taking action to stop being served by the second cell or avoid being handed over to the second cell in response to the detection.

Certain aspects of the present disclosure provide a computer-readable medium for wireless communication by a user equipment (UE). The computer-readable medium generally includes instructions executable by one or more processor for detecting the occurrence of one or more conditions while the UE is in a region of cell range expansion (CRE) in which the UE may be handed over from a first cell of a first power class type to a second cell of a second power class type, wherein the second power class type is lower than the first power class type, and taking action to stop being served by the second cell or avoid being handed over to the second cell in response to the detection.

Certain aspects of the present disclosure provide an apparatus for wireless communications by a user equipment (UE). The apparatus generally includes at least one processor configured to detect the occurrence of one or more conditions while the UE is in a region of cell range expansion (CRE) in which the UE may be handed over from a first cell of a first power class type to a second cell of a second power class type, wherein the second power class type is lower than the first power class type, and take action to stop being served by the second cell or avoid being handed over to the second cell in response to the detection.

Numerous other aspects are provided including apparatus, systems and computer program products. Various aspects and features of the disclosure are described in further detail below.

### BRIEF DESCRIPTION OF THE DRAWINGS

FIG. 1 is a block diagram conceptually illustrating an example of a wireless communications network in accordance with certain aspects of the present disclosure.

FIG. 2 is a block diagram conceptually illustrating an example of a frame structure in a wireless communications network in accordance with certain aspects of the present disclosure.

FIG. 2A shows an example format for the uplink in Long Term Evolution (LTE) in accordance with certain aspects of the present disclosure.

FIG. 3 shows a block diagram conceptually illustrating an example of a enhanced Node B in communication with a user equipment device (UE) in a wireless communications network in accordance with certain aspects of the present disclosure.

FIG. 4 illustrates an example heterogeneous network in accordance with certain aspects of the present disclosure.

FIG. 5 illustrates example resource partitioning in a heterogeneous network in accordance with certain aspects of the present disclosure.

FIG. 6 illustrates example cooperative partitioning of subframes in a heterogeneous network in accordance with certain aspects of the present disclosure.

FIG. 7 is a diagram illustrating a range expanded cellular region in a heterogeneous network.

FIG. 8 illustrates example operations that may be performed by a UE, to avoid and/or escape cell range expansion, in accordance with certain aspects of the present disclosure.

FIG. 9 illustrates an example system for implementing avoidance and/or escaping cell range expansion, in accordance with certain aspects of the present disclosure.

### DETAILED DESCRIPTION

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

### Example Wireless Network

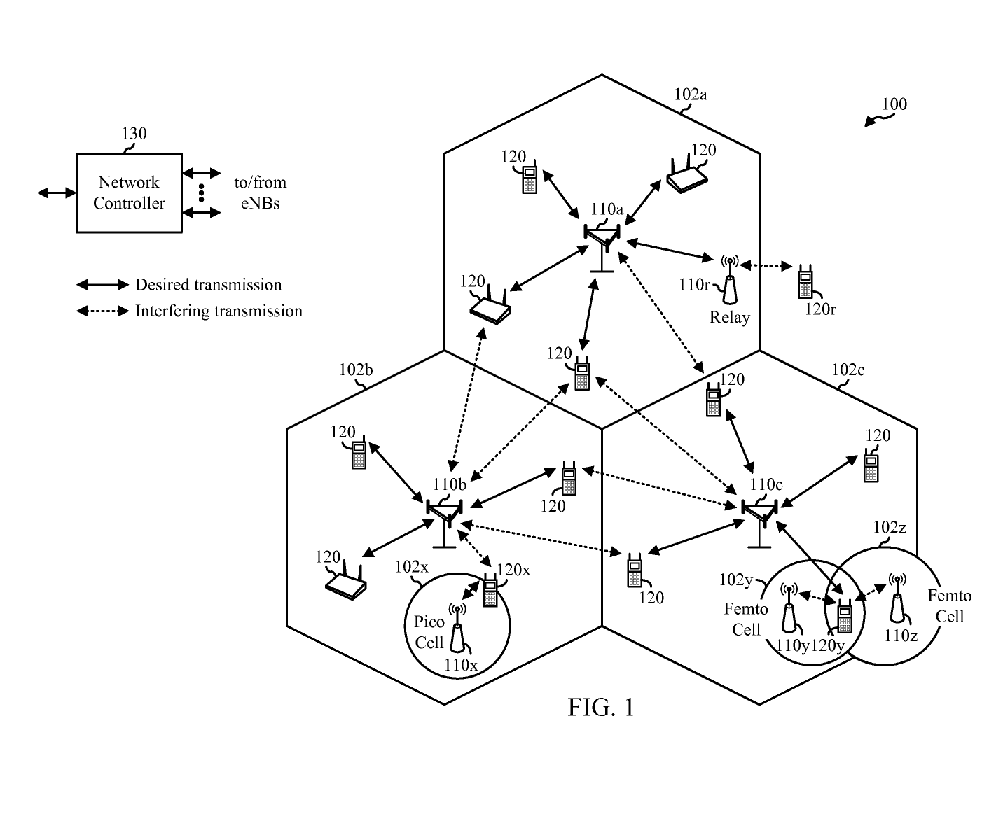

FIG. 1 shows a wireless communication network 100, which may be an LTE network. The wireless network 100 may include a number of evolved Node Bs (eNBs) 110 and other network entities. An eNB may be a station that communicates with user equipment devices (UEs) and may also be referred to as a base station, a Node B, an access point, etc. Each eNB 110 may provide communication coverage for a particular geographic area. The term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB. An eNB for a pico cell may be referred to as a pico eNB. An eNB for a femto cell may be referred to as a femto eNB or a home eNB. In the example shown in FIG. 1, eNBs 110a, 110b, and 110c may be macro eNBs for macro cells 102a, 102b, and 102c, respectively. eNB 110x may be a pico eNB for a pico cell 102x. eNBs 110y and 110z may be femto eNBs for femto cells 102y and 102z, respectively. An eNB may support one or multiple (e.g., three) cells.

The wireless network 100 may also include relay stations. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with eNB 110a and a UE 120r in order to facilitate communication between eNB 110a and UE 120r. A relay station may also be referred to as a relay eNB, a relay, etc.

The wireless network 100 may be a heterogeneous network that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 watts) whereas pico eNBs, femto eNBs, and relays may have a lower transmit power level (e.g., 1 watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a tablet, etc. A UE may be able to communicate with macro eNBs, pico eNBs, femto eNBs, relays, etc. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz, and there may be 1, 2, 4, 8, or 16 subbands for system bandwidth of 1.25, 2.5, 5, 10, or 20 MHz, respectively.

A UE may be within the coverage of multiple eNBs. One of these eNBs may be selected to serve the UE. The serving eNB may be selected, for example, based on various criteria such as received power, received quality, path loss, signal-to-noise ratio (SNR), etc.

A UE may operate in a dominant interference scenario in which the UE may observe high interference from one or more interfering eNBs. A dominant interference scenario may occur due to restricted association. For example, in FIG. 1, UE 120y may be close to femto eNB 110y and may have high received power for eNB 110y. However, UE 120y may not be able to access femto eNB 110y due to restricted association and may then connect to macro eNB 110c with lower received power (as shown in FIG. 1) or to femto eNB 110z also with lower received power. UE 120y may then observe high interference from femto eNB 110y on the downlink and may also cause high interference to eNB 110y on the uplink.

A dominant interference scenario may also occur due to range extension, which is a scenario in which a UE connects to an eNB with lower path loss and lower SNR among all eNBs detected by the UE. For example, in FIG. 1, UE 120x may detect macro eNB 110b and pico eNB 110x and may have lower received power for eNB 110x than eNB 110b. Nevertheless, it may be desirable for UE 120x to connect to pico eNB 110x if the path loss for eNB 110x is lower than the path loss for macro eNB 110b. This may result in less interference to the wireless network for a given data rate for UE 120x. However, in certain cases, being served by the pico eNB 110x while in a cell range expansion (CRE) region of the pico eNB 110x may not provide much benefit and in fact may lead to service interruption. In accordance with certain aspects of the present disclosure, the UE 120x may avoid being served by the pico eNB 110x, in response to detecting certain conditions including high doppler, high relative timing/frequency offset, processing limitations, and/or low battery power. These aspects are discussed in detail below.

In an aspect, communication in a dominant interference scenario may be supported by having different eNBs operate on different frequency bands. A frequency band is a range of frequencies that may be used for communication and may be given by (i) a center frequency and a bandwidth or (ii) a lower frequency and an upper frequency. A frequency band may also be referred to as a band, a frequency channel, etc. The frequency bands for different eNBs may be selected such that a UE can communicate with a weaker eNB in a dominant interference scenario while allowing a strong eNB to communicate with its UEs. An eNB may be classified as a “weak” eNB or a “strong” eNB based on the relative received power of signals from the eNB received at a UE (e.g., and not based on the transmit power level of the eNB).

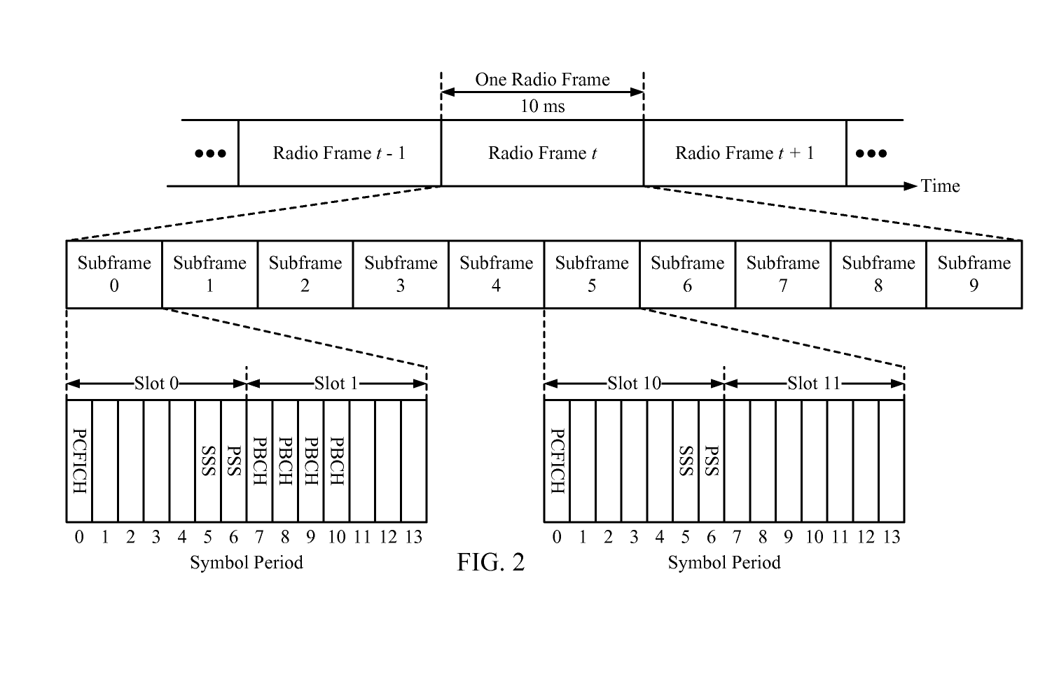

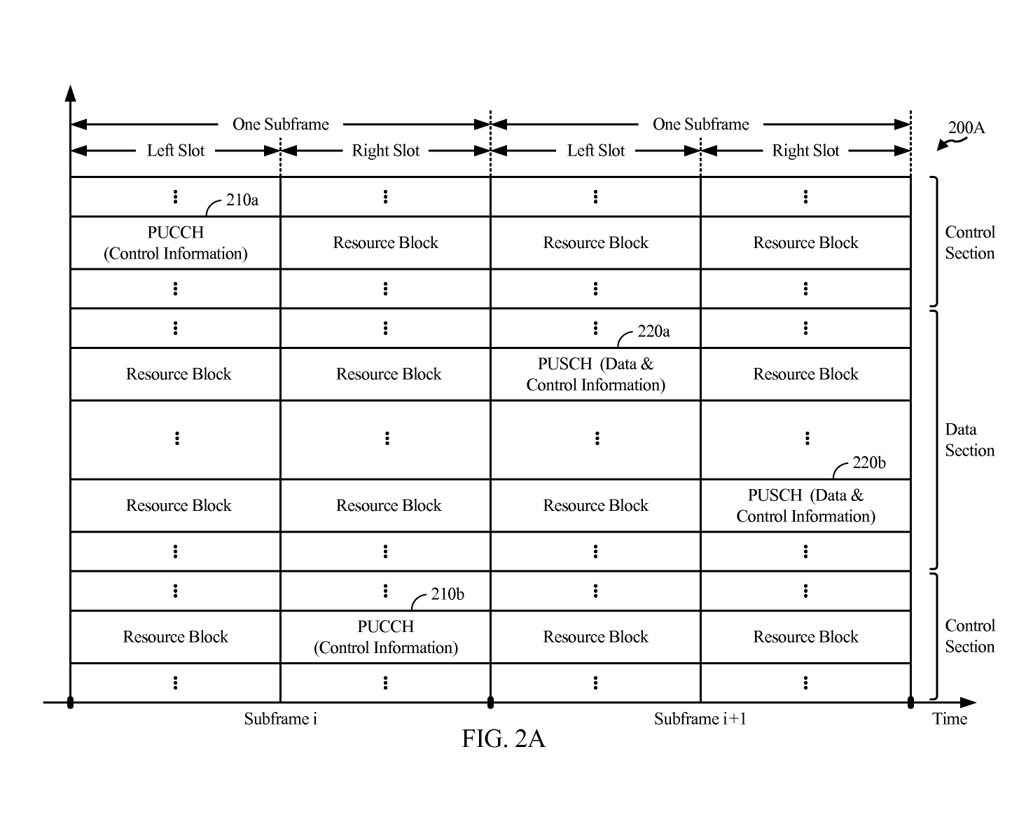

FIG. 2 shows a frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., L=7 symbol periods for a normal cyclic prefix (as shown in FIG. 2) or L=6 symbol periods for an extended cyclic prefix. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP), as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe, as shown in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe (not shown in FIG. 2). The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

FIG. 2A shows an exemplary format 200A for the uplink in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 2A results in the data section including contiguous subcarriers, which may allow a single UE to be assigned all of the contiguous subcarriers in the data section.

A UE may be assigned resource blocks in the control section to transmit control information to an eNB. The UE may also be assigned resource blocks in the data section to transmit data to the Node B. The UE may transmit control information in a Physical Uplink Control Channel (PUCCH) 210a, 210b on the assigned resource blocks in the control section. The UE may transmit data or both data and control information in a Physical Uplink Shared Channel (PUSCH) 220a, 220b on the assigned resource blocks in the data section. An uplink transmission may span both slots of a subframe and may hop across frequency as shown in FIG. 2A.

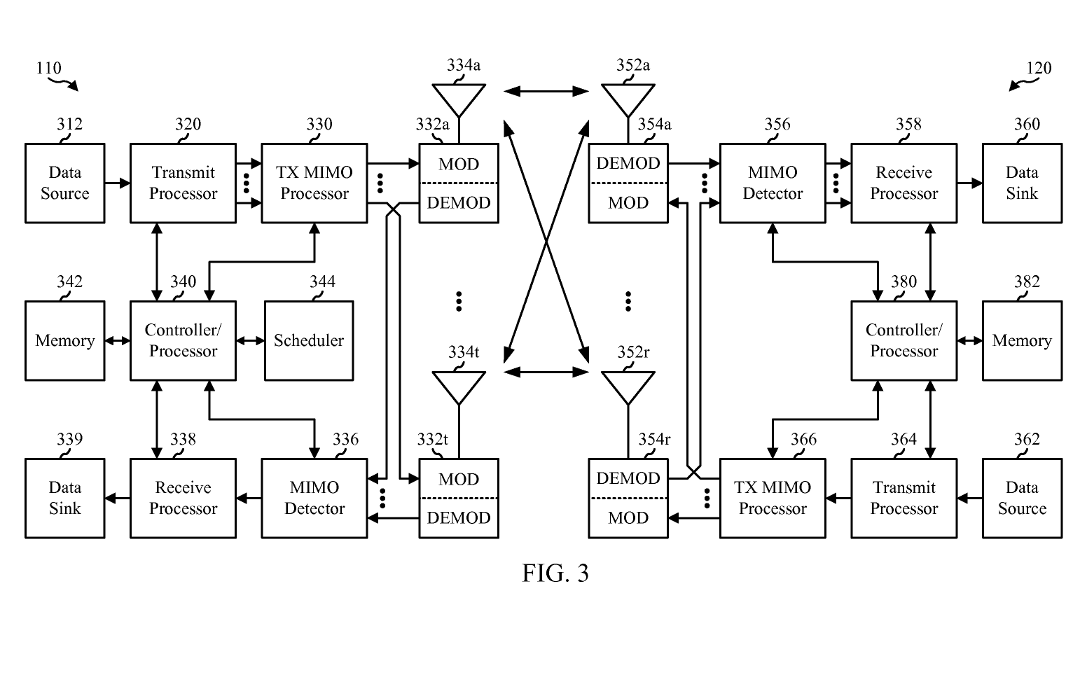

FIG. 3 shows a block diagram of a design of a base station or an eNB 110 and a UE 120, which may be one of the base stations/eNBs and one of the UEs in FIG. 1. For a restricted association scenario, the eNB 110 may be macro eNB 110c in FIG. 1, and UE 120 may be UE 120y. The eNB 110 may also be a base station of some other type. The eNB 110 may be equipped with T antennas 334a through 334t, and the UE 120 may be equipped with R antennas 352a through 352r, where in general T 1 and R≧1.

At the eNB 110, a transmit processor 320 may receive data from a data source 312 and control information from a controller/processor 340. The control information may be for the PBCH, PCFICH, PHICH, PDCCH, etc. The data may be for the PDSCH, etc. The transmit processor 320 may process (e.g., encode and symbol map) the data and control information to obtain data symbols and control symbols, respectively. The transmit processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide T output symbol streams to T modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. T downlink signals from modulators 332a through 332t may be transmitted via T antennas 334a through 334t, respectively.

At the UE 120, antennas 352a through 352r may receive the downlink signals from the eNB 110 and may provide received signals to demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all R demodulators 354a through 354r, perform MIMO detection on the received symbols, if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The transmit processor 364 may also generate reference symbols for a reference signal. The symbols from the transmit processor 364 may be precoded by a TX MIMO processor 366 if applicable, further processed by modulators 354a through 354r (e.g., for SC-FDM, etc.), and transmitted to the eNB 110. At the eNB 110, the uplink signals from the UE 120 may be received by antennas 334, processed by demodulators 332, detected by a MIMO detector 336 if applicable, and further processed by a receive processor 338 to obtain decoded data and control information sent by the UE 120. The receive processor 338 may provide the decoded data to a data sink 339 and the decoded control information to the controller/processor 340.

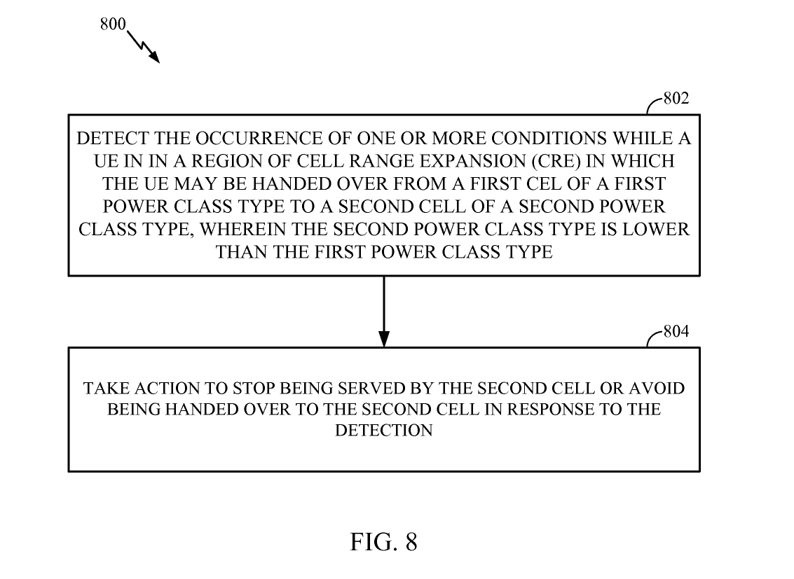

The controllers/processors 340, 380 may direct the operation at the eNB 110 and the UE 120, respectively. The controller/processor 380 and/or other processors and modules at the UE 120 may perform or direct operations for blocks 800 in FIG. 8, and/or other processes for the techniques to stop being served by or avoid being served by a cell of lower power class, e.g., pico cell, as described herein. The memories 342 and 382 may store data and program codes for UE 120, respectively. A scheduler 344 may schedule UEs for data transmission on the downlink and/or uplink.

### Example Resource Partitioning

According to certain aspects of the present disclosure, when a network supports enhanced inter-cell interference coordination (eICIC), the base stations may negotiate with each other to coordinate resources in order to reduce or eliminate interference by the interfering cell's giving up part of its resources. Using eICIC or similar techniques, a UE may access a serving cell using the resources yielded by the interfering cell, where otherwise the UE would experience severe interference.

For example, a femto cell with a closed access mode (e.g., only a member femto UE can access the cell) in an open macro cell's coverage can create a coverage hole for a macro cell. By making a femto cell give up some of its resources, the macro UE under the femto cell coverage area can access the UE's serving macro cell by using the resources yielded by a femto cell.

In a radio access system using OFDM, such as E-UTRAN, the resources yielded by the interfering cell may be time-based, frequency-based, or a combination of both. When the yielded resources are time-based, the interfering cell does not use some of the subframes in the time domain. When the yielded resources are frequency-based, the interfering cell does not use some of the subcarriers in the frequency domain. When the yielded resources are a combination of both frequency and time, the interfering cell does not use certain resources defined by frequency and time.

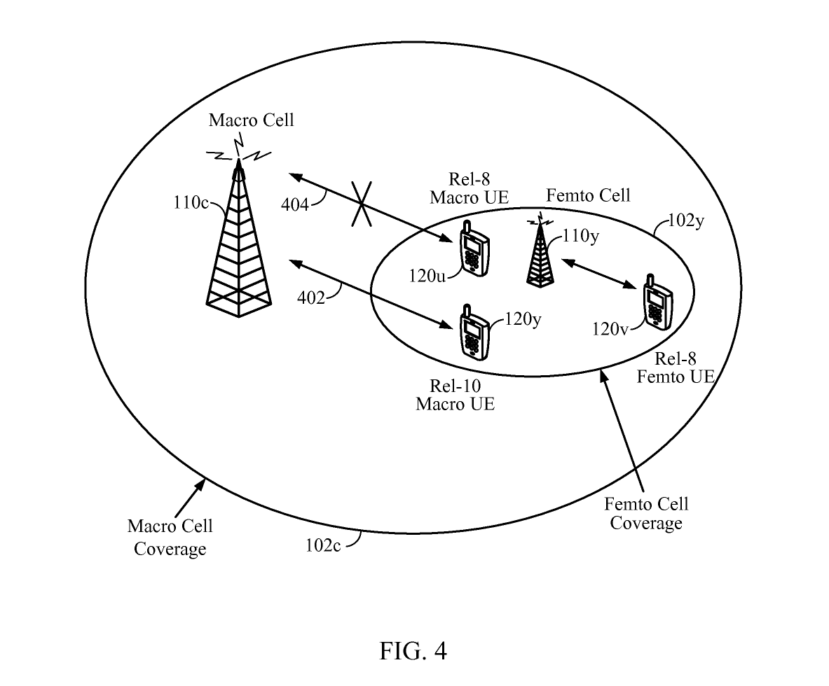

FIG. 4 illustrates an example scenario where eICIC may allow the macro UE 120y supporting eICIC (e.g., a Rel-10 macro UE as shown in FIG. 4) to access the macro cell 110c even when the macro UE 120y is experiencing severe interference from the femto cell 110y, as illustrated by the solid radio link 402. A legacy macro UE 120u (e.g., a Rel-8 macro UE as shown in FIG. 4) may not be able to access the macro cell 110c under severe interference from the femto cell 110y, as illustrated by the broken radio link 404. A femto UE 120v (e.g., a Rel-8 femto UE as shown in FIG. 4) may access the femto cell 110y without any interference problems from the macro cell 110c.

According to certain aspects, the resource partitioning between base stations may be done time based. As an example, for E-UTRAN, resources may be partitioned by subframes.

According to certain aspects, networks may support enhanced interference coordination, where there may be different sets of partitioning information. A first of these may be referred to as Semi-static Resource Partitioning Information (SRPI). A second of these sets may be referred to as Adaptive Resource Partitioning Information (ARPI). As the name implies, SRPI typically does not change frequently, and SRPI may be sent to the UE so that the UE can use the resource partitioning information for the UE's own operations.

As an example, the resource partitioning may be implemented with 8 ms periodicity (8 subframes) or 40 ms periodicity (40 subframes). According to certain aspects, it may be assumed that frequency division duplexing (FDD) may also be applied such that frequency resources may also be partitioned. For the downlink (e.g., from an eNB to a UE), the partitioning pattern may be mapped to a known subframe (e.g., a first subframe of each radio frame that has a system frame number (SFN) value that is a multiple of an integer N, such as multiples of 4). Such a mapping may be applied in order to determine resource partitioning information for a specific subframe. As an example, a subframe that is subject to coordinated resource partitioning (e.g., yielded by an interfering cell) for the downlink may be identified by an index:

IndexSRPI_DL=(SFN*10+subframe number)mod 8

For the uplink, the SRPI mapping may be shifted, for example, by 4 ms. Thus, an example for the uplink may be:

IndexSRPI_UL=(SFN*10+subframe number+4)mod 8

SRPI may use the following three values for each entry:
U (Use): this value indicates the subframe has been cleaned up from the dominant interference to be used by this cell (i.e., the main interfering cells do not use this subframe);
N (No Use): this value indicates the subframe shall not be used; and
X (Unknown): this value indicates the subframe is not statically partitioned. Details of resource usage negotiation between base stations are not known to the UE.

Another possible set of parameters for SRPI may be the following:
U (Use): this value indicates the subframe has been cleaned up from the dominant interference to be used by this cell (i.e., the main interfering cells do not use this subframe);
N (No Use): this value indicates the subframe shall not be used;
X (Unknown): this value indicates the subframe is not statically partitioned (and details of resource usage negotiation between base stations are not known to the UE); and
C (Common): this value may indicate all cells may use this subframe without resource partitioning. This subframe may be subject to interference, so that the base station may choose to use this subframe only for a UE that is not under severe interference.

The serving cell's SRPI may be broadcasted over the air. In E-UTRAN, the SRPI of the serving cell may be sent in a master information block (MIB), or one of the system information blocks (SIBs). A predefined SRPI may be defined based on the characteristics of cells, e.g., macro cell, pico cell (with open access), and femto cell (with closed access). In such a case, encoding of SRPI in the system overhead message may result in more efficient broadcasting over the air.

The base station may also broadcast the neighbor cell's SRPI in one of the SIBs. For this, SRPI may be sent with its corresponding range of physical cell identities (PCIs).

ARPI may represent further resource partitioning information with the detailed information for the ‘X’ subframes in SRPI. As noted above, detailed information for the ‘X’ subframes is typically only known to the base stations.

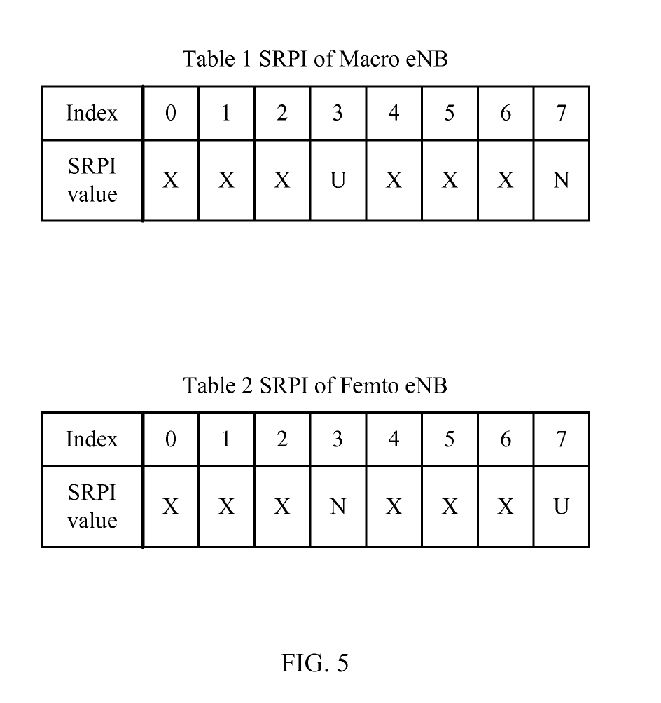

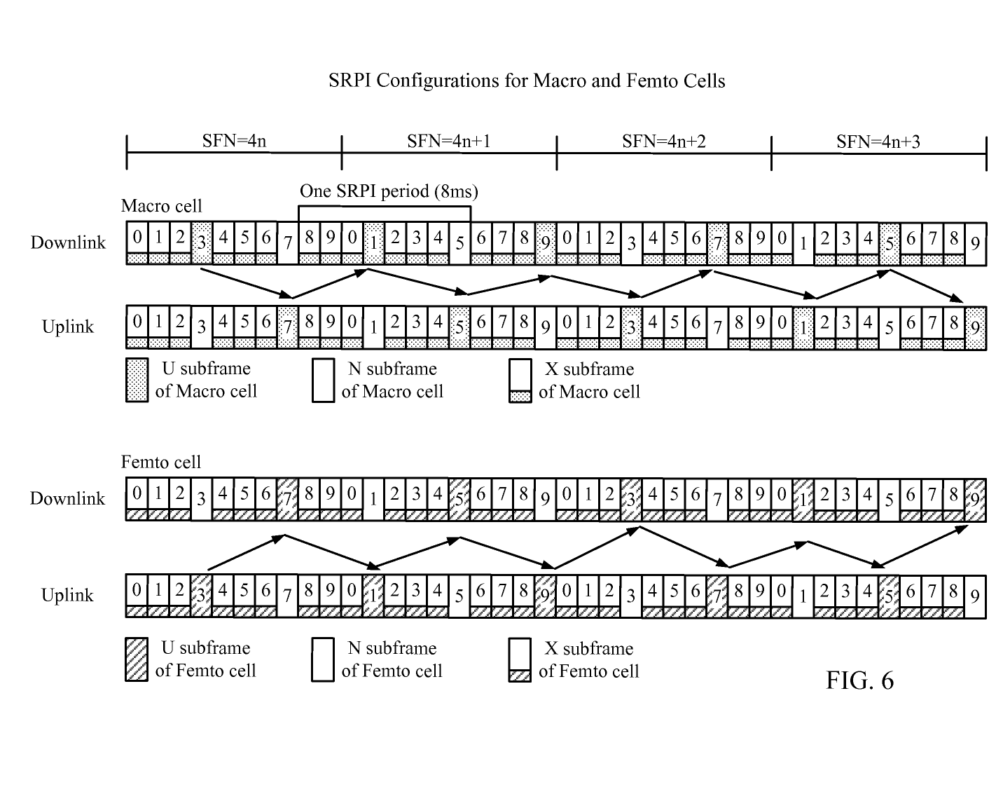

FIG. 5 and FIG. 6 illustrate examples of SRPI assignment as described above in the scenario with macro and femto cells. A U, N, X, or C subframe is a subframe corresponding to a U, N, X, or C SRPI assignment.

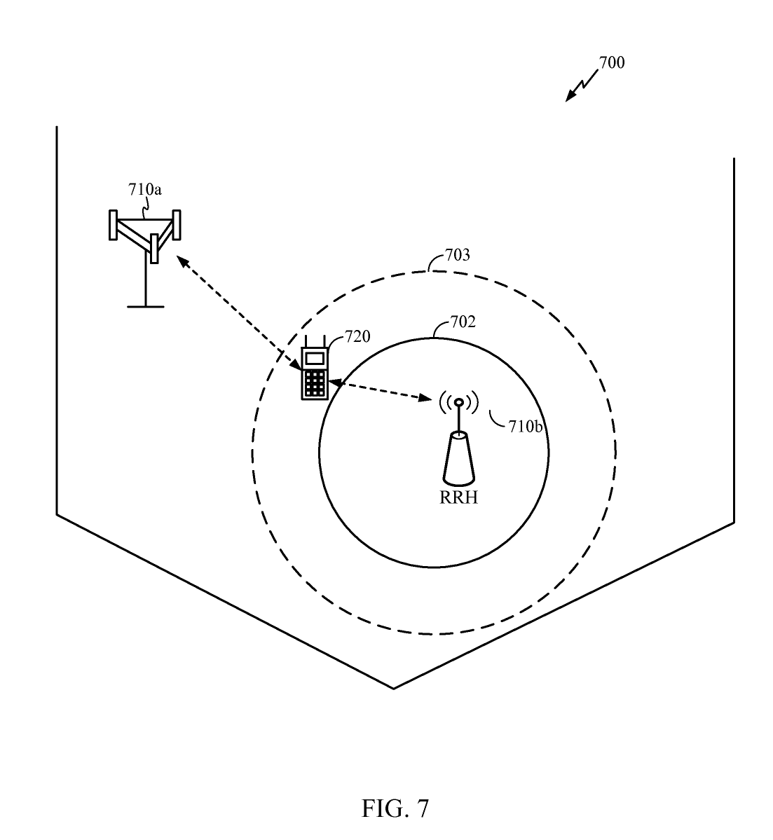

FIG. 7 is a diagram 700 illustrating a range expanded cellular region in a heterogeneous network. A lower power class eNB such as the RRH 710b may have a range expanded cellular region 703 that is expanded from the cellular region 702 through enhanced inter-cell interference coordination between the RRH 710b and the macro eNB 710a and/or through interference cancelation performed by the UE 720. In enhanced inter-cell interference coordination, the RRH 710b receives information from the macro eNB 710a regarding an interference condition of the UE 720. The information allows the RRH 710b to serve the UE 720 in the range expanded cellular region 703 and to accept a handoff of the UE 720 from the macro eNB 710a as the UE 720 enters the range expanded cellular region 703. In an aspect, the RRH 710 may include a pico eNB.

Thus, an eICIC technique allows cells belonging to different power classes to coexist and share resources in a heterogeneous network. As shown in FIG. 7, eICIC may allow the UE 720 to receive service from a cell (RRH 710b) that is not the strongest cell in the vicinity of the UE, thus allowing offload from the macro cell to a relatively low power pico cell.

In certain aspects, the eICIC technique may include an aggressor cell eNB (e.g., macro cell eNB 710a) generating certain special subframes (e.g., uplink or downlink subframes) in which the macro eNB 710a limits transmissions in an effort to reduce interference to other cells/base stations in the macro cell's vicinity. For example, the stronger macro cell may generate almost blank subframes (ABS) (e.g., U subframes in FIG. 6), allowing signals of a weaker cell (e.g., pico cell) to be received at the UE using the ABS resources.

In certain aspects, the pattern of the ABS of an aggressor cell (e.g. macro cell) is typically shared with the eNBs of the victim cells so that a victim eNB (e.g. pico eNB) may serve one or more UEs using this ABS resource, e.g., in a cell range expansion (CRE) area where interference is especially severe. For example, in a heterogeneous network including a macro cell and pico cell (e.g., macro-pico case), the ABS may be scheduled by the macro cell, and the macro cell may inform resource partitioning information including information regarding the ABS resources to the pico cell. The ABS resources may then be used by the pico cell to serve UEs for which the pico cell is not the strongest cell, for example, UEs in the CRE region.

In certain scenarios, e.g., high Doppler situations, the eICIC may not be very effective in establishing a proper communication channel between the UE and a pico cell, which may lead to service interruption. Thus, in certain aspects of the present disclosure, in order to minimize service interruption due to the fact that the UE is served by a weak pico cell in a CRE region in the presence of strong interference from a macro aggressor cell, the UE may avoid CRE. For example, the UE may avoid being served by a pico cell in a region of CRE, in the presence of a strong macro cell.

### Example Methods and Apparatus for Avoiding and Escaping Cell Range Expansion (CRE) in a Heterogeneous Network

Certain aspects of the present disclosure discuss techniques that enable the UE to leave or escape CRE (e.g., such that the UE is no longer served by a victim cell, and may be served by a stronger cell, possibly an aggressor cell) in a timely manner if the UE is, for example, already camped on to a pico cell, or avoid entering CRE (e.g., such that the UE may continue being served by a stronger cell, possibly the aggressor cell, and may not be handed over to a victim cell) if the UE is, for example, camped on to the macro cell. It may be noted that macro and pico cells are used for illustrative and exemplary purposes only, and that the techniques discussed herein are applicable to any region of CRE with overlapping coverage from cells of different power classes.

### CRE Avoidance

In certain aspects, while in a region of CRE and being served by a macro cell, a UE may avoid being handed over to a cell of a lower power class, e.g., a pico cell in case the UE detects occurrence of one or more conditions.

In an aspect, the UE may avoid entering CRE if it detects high Doppler, for example, above a predetermined Doppler threshold. A high Doppler may mean, for example, that the UE, after being handed over from the macro to the pico, may stay in the pico coverage for a very short period of time after which it may have to be handed back to the macro. Entering CRE in such high Doppler cases may provide little benefit and it may be advisable for the UE to avoid entering the CRE for such short durations. For example, for a pico coverage of about 100m, if the UE is moving at above 60 Km/h, the UE may be configured to avoid entering the CRE.

In an aspect, the UE may avoid entering CRE if it detects a large relative timing and/or frequency offset among neighboring strong macro cell and weak pico cell. In certain aspects, the eICIC relies on a tight synchronization (e.g., in both time and frequency) between the macro and pico cells, for example, to enable the UE to detect a signal from the macro and cancel it. A large relative timing and/or frequency offset between the macro and the pico cells may make this interference cancellation of the macro signal ineffective. Thus, the UE may be configured to avoid being handed over to the pico cell if it detects a large timing and/or frequency offset, e.g., larger than a predetermined threshold.

In certain aspects, the UE may avoid entering CRE if it detects UE processing limitations. For example, if the UE is handling a delay sensitive task, it may not want any service interruption, e.g., due to handover to the pico cell in the CRE region. Another example, is when the UE is cycle limited and/or has limited capability or bandwidth for the additional processing to handle CRE. While in CRE, the UE needs more processing cycles as compared to being served by the macro cell. Thus, if the UE is cycle limited and does not have any more cycles to spare for the extra processing for the CRE, for example, it may avoid entering CRE. Additionally or alternatively, if the UE does not have enough hardware resources (e.g., memory) available for the extra processing (e.g., interference cancellation) in the CRE, it may avoid entering the CRE.

In certain aspects, the UE uses more battery power in CRE, for example, to accommodate the extra processing of the CRE. Thus, the UE may be configured to avoid entering the CRE if it detects that the UE is low on battery power.

In certain aspects, in response to detecting one or more of the above discussed conditions, the UE may take one or actions to avoid entering CRE, e.g., refrain from being handed over to the pico cell. Generally, the decision of whether a UE will hand over to the pico cell in a CRE region is taken at the network end (e.g., macro cell). Thus, the UE may need to take one or more actions so that the network does not handover the UE to the pico cell.

In certain aspects, the UE may report an artificially low RSRP (Reference Signal Received Power) and/or RSRQ (Reference Signal Received Quality) to indicate a weak pico cell. For example, the UE may report RSRP for the pico cell that is lower than the actual RSRP measurement for the pico cell. In an aspect, the UE may report an RSRP for the pico cell low enough, e.g., below a predetermined threshold value, so that the network decides not to handover the UE to the pico cell. For example, if the UE measures RSRPs of 100 dB for the macro and 95 dB for the pico and reports the actual measurement for the pico, the macro may most likely handover the UE to the pico. However, if the UE decides not to handover to the pico based on one or more of the above discussed conditions, it may report a value of the pico RSRP that is less than the actual measured value, e.g., 60 dB to avoid the likelihood of being handed over to the pico cell.

In certain aspects, even if the UE can detect the pico cell, the UE may not report any measurements for the pico cell (e.g., as if no pico cell was detected). In an aspect, as long as the UE does not report measurements for the pico cell, it may not be handed over to the pico cell.

### CRE Escape

In certain aspects, while in a region of CRE and being served by a pico cell, a UE may attempt to hand over to a cell of higher power class, e.g., macro cell, in case the UE detects occurrence of one or more conditions.

In an aspect, the UE may attempt to leave CRE if it detects high Doppler while in CRE, for example, above a predetermined Doppler threshold. Remaining in CRE in high Doppler cases may provide little benefit and it may be advisable for the UE to leave the CRE at the earliest possible instance.

In an aspect, the UE may attempt to leave CRE if it detects a large relative timing and/or frequency offset among neighboring strong macro cell and weak serving pico cell. As noted above, a large relative timing and/or frequency offset between the macro and the pico cells may make interference cancellation of the macro signal ineffective. Thus, the UE may be configured to leave CRE and hand over to the macro cell if it detects a large timing and/or frequency offset, e.g., larger than a predetermined threshold.

In certain aspects, the UE may attempt to leave CRE if RLM (Radio link Monitoring) SNR drops below a particular threshold. In an aspect, this threshold may be set greater than Radio Link Failure (RLF) threshold. The UE may locally maintain the RLM SNR threshold slightly higher than the RLF threshold, e.g., 5 to 10 db higher than the RLF threshold.

In certain aspects, the UE may also attempt to leave the CRE if it detects UE processing limitations and/or low battery power as noted above.

In certain aspects, in response to detecting one or more of the above discussed conditions, the UE may take one or actions to leave the CRE, e.g., hand over to macro cell.

In certain aspects, the UE may report an artificially low RSRP (Reference Signal Received Power) and/or RSRQ (Reference Signal Received Quality) to indicate a weak serving pico cell to trigger a handover to a stronger macro cell. For instance the UE may report RSRP for the pico cell that is lower than the actual RSRP measurement for the pico cell. In an aspect, the UE may report an RSRP for the serving pico cell low enough, e.g., below a predetermined threshold value, so that the network decides to handover the UE to the macro cell.

In certain aspects, the UE may initiate RLF procedures and re-select a stronger cell (e.g., macro cell) as its serving cell, for example, when the RLM SNR is detected below the internal threshold discussed above.

In certain aspects, the UE may autonomously switch to RRC_IDLE state and may follow a UE-controlled mobility procedure to select a stronger cell (e.g., macro cell) as its serving cell.

FIG. 8 illustrates example operations 800 that may be performed by a UE, to avoid and/or escape cell range expansion, in accordance with certain aspects of the present disclosure. Operations 800 may begin, at 802, by detecting the occurrence of one or more conditions while the UE is in a region of CRE in which the UE may be handed over from a first cell of a first power class type to a second cell of a second power class type, wherein the second power class type is lower than the first power class type. At 804, the UE may take action to stop being served by the second cell or avoid being handed over to the second cell in response to the detection.

In certain aspects, detecting occurrence of the one or more conditions may include of detecting at least one of mobility of the UE above a threshold value, detecting a relative timing offset between the first and second cells above a threshold value, detecting a relative frequency offset between the first and second cells above a threshold value, detecting a condition relating to processing limitations of the UE, detecting a condition relating to power limitations of the UE, or detecting a RLM SNR below a threshold value. In an aspect, the UE may detect that the UE is handling a delay sensitive task.

In certain aspects, taking action may include at least one of reporting artificially low RSRP for the second cell, reporting an artificially low RSRQ for the second cell, refraining from reporting measurements of the second cell, initiating a RLF procedure in the second cell, or entering a RRC idle state in the second cell.

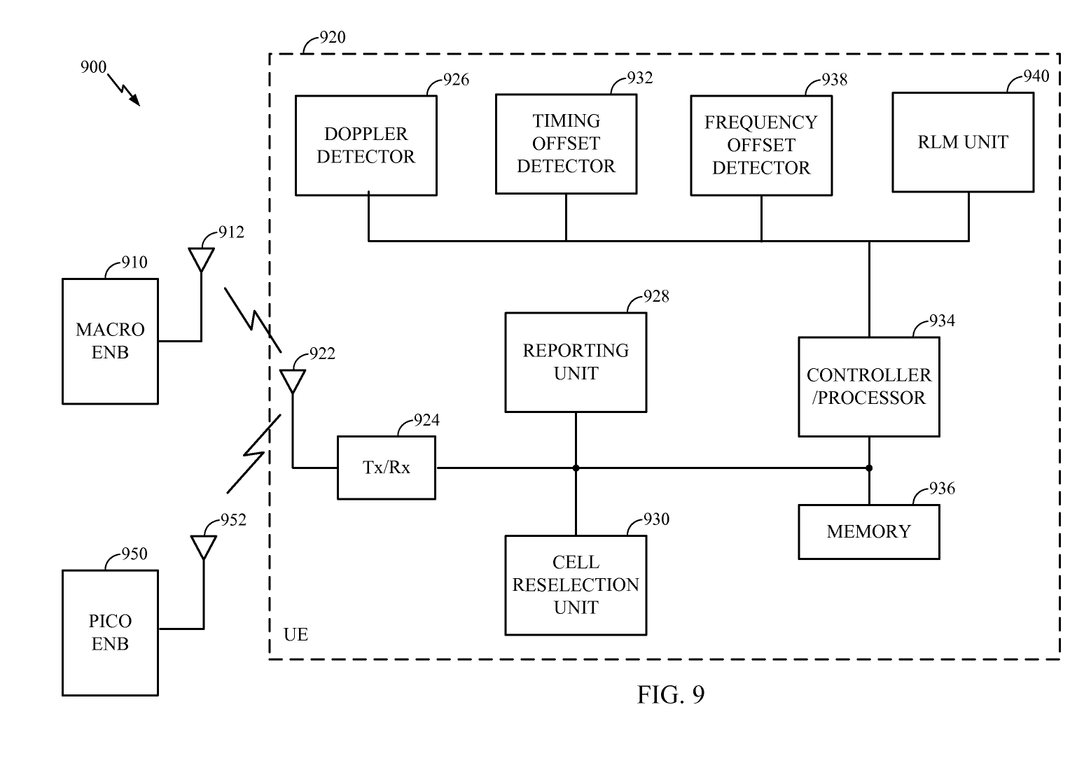

FIG. 9 illustrates an example system 900 for implementing avoidance and/or escaping cell range expansion, in accordance with certain aspects of the present disclosure.

System 900 may include a macro eNB 910, a pico eNB 950, and at least one UE 920 capable of communicating with both the macro eNB 910 and the pico eNB 950. In certain aspects, the UE may be positioned in a CRE region of the pico eNB 950 also having overlapping coverage from the macro eNB 910.

The UE 920 may include various modules including a doppler detector 926, a timing offset detector 932, a frequency offset detector 938, an RLM unit 940, a reporting unit 928 and a cell re-selection unit 930, all coupled to a controller/processor 934. The controller/processor 934 may further be coupled to a transceiver (Tx/Rx) 924 and a memory 936. In an aspect, the controller/processor 934 may be configured to control operation of each of the modules of the UE 920. For example, the controller/processor 934 may be configured to receive input signals from one or more modules of the UE 920, process these signals, for example based on instructions and data stored in the memory 936, and control one or more modules to perform certain operations or output desired signals. The macro eNB 910 and the pico eNB 952 may communicate with the UE 920 by transmitting and receiving signals via their respective antennas 912 and 952. The transceiver 924 may be configured to receive or transmit signals via antenna 922. In an aspect, the memory 936 may store instructions accessible and implementable by the controller/processor 934 for performing one or more operations in order to avoid and/or escape the CRE region of the pico eNB 952. It may be appreciated that each of the UE modules are illustrated as separate units for illustrative and exemplary purposes only, and that one or more of the UE modules may be combined.

In an aspect, the doppler detector may measure the doppler of the UE 920 and reports (e.g., periodically or upon request) a measured doppler value to the controller/processor 934. The timing offset detector 932 and the frequency offset detector 938 may measure relative timing and frequency offsets respectively between the macro eNB 910 and the pico eNB 950, and report (e.g., periodically or upon request) a measured timing offset value and a measured frequency offset value respectively to the controller/processor 934. The RLM unit 940 may monitor the radio link between the pico eNB 950 and the UE 920, measure an RLM SNR, and report a value of the RLM SNR (e.g., periodically or upon request) to the controller/processor 934.

In certain aspects, as discussed above, while in the region of the CRE and being served by the macro eNB 910, the UE 920 may avoid being handed over to the pico eNB 950 if it detects occurrence of one or more conditions. Additionally or alternatively, as also discussed above, while in the region of the CRE and being served by the pico eNB 950, the UE 920 may attempt to hand over to the macro eNB 910 if it detects occurrence of one or more conditions. For example, the controller/processor 934 may determine that the UE must avoid being handed over to the pico eNB 950 or hand over to the macro eNB 910, if it detects one or more of the conditions including the measured doppler higher than a threshold, the measured relative timing offset higher than a threshold, and the measured relative frequency offset higher than a threshold. Additionally or alternatively, the controller/processor 934 may be configured to detect delay sensitive tasks and whether processing of the delay sensitive tasks may be delayed beyond acceptable levels due to processing limitations at the UE 920. The controller/processor 934 may decide that the UE must avoid being handed over to the pico eNB 950 or hand over to the macro eNB 910 to ease the processing load on the UE 920. Additionally or alternatively, the controller/processor 934 may be configured to detect low battery power situation at the UE 920, and determine to avoid handover to pico eNB 950 or handover the UE 920 to the macro eNB 910 to save battery power. Additionally or alternatively, while being served by the pico eNB 950 in the CRE region, the controller/processor 934 may decide to handover the UE 920 to the macro eNB 910, if it detects that the measured RLM SNR has dropped below a threshold.

In certain aspects, the controller/processor may determine to take one or more actions to stop being served by the pico eNB 950 or avoid handover to the pico eNB 950, in response to detecting one or more conditions discussed above. For example, on deciding that the UE must avoid being handed over to the pico eNB 950 or that the UE must handover to the macro eNB 910, the controller/processor 934 may direct the transceiver 924 to report an artificially low RSRP/RSRQ for the pico eNB 950 or to refrain from reporting measurements for the pico eNB 950 at all. Further, the controller/processor 934 may initiate RLF procedure for the pico eNB 950 or enter an RRC idle state in a pico cell served by the pico eNB 950.

The various operations of methods described above may be performed by any suitable means capable of performing the corresponding functions. The means may include various hardware and/or software component(s) and/or module(s), including, but not limited to a circuit, an application specific integrated circuit (ASIC), or processor.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and/or write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, a phrase referring to “at least one of” a list of items refers to any combination of those items, including single members. As an example, “at least one of: a, b, or c” is intended to cover: a, b, c, a-b, a-c, b-c, and a-b-c.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for wireless communication by a user equipment (UE), comprising:
detecting the occurrence of one or more conditions while the UE is in a region of cell range expansion (CRE) in which the UE may be handed over from a first cell of a first power class type to a second cell of a second power class type, wherein the second power class type is lower than the first power class type; and
taking action to stop being served by the second cell or avoid being handed over to the second cell in response to the detection.

2. The method of claim 1, wherein detecting the occurrence of one or more conditions comprises detecting mobility of the UE above a threshold value.

3. The method of claim 1, wherein detecting the occurrence of one or more conditions comprises detecting at least one of: a relative timing offset between the first and second cells above a threshold value or a relative frequency offset between the first and second cells above a threshold value.

4. The method of claim 1, wherein detecting the occurrence of one or more conditions comprises detecting a condition relating to at least one of processing or power limitations of the UE.

5. The method of claim 4, wherein detecting a condition relating to at least one of processing or power limitations of the UE includes detecting the UE is handling a delay sensitive task.

6. The method of claim 1, wherein detecting the occurrence of one or more conditions comprises detecting a Radio Link Monitoring (RLM) Signal to Noise Ratio (SNR) below a threshold value.

7. The method of claim 1, wherein taking action comprises at least one of: reporting an artificially low RSRP for the second cell or reporting an artificially low RSRQ for the second cell.

8. The method of claim 1, wherein taking action comprises refraining from reporting measurements of the second cell.

9. The method of claim 1, wherein taking action comprises initiating a radio link failure (RLF) procedure in the second cell.

10. The method of claim 1, wherein taking action comprises entering a radio resource control (RRC) idle state in the second cell.

11. An apparatus for wireless communication by a user equipment (UE), comprising:
means for detecting the occurrence of one or more conditions while the UE is in a region of cell range expansion (CRE) in which the UE may be handed over from a first cell of a first power class type to a second cell of a second power class type, wherein the second power class type is lower than the first power class type; and
means for taking action to stop being served by the second cell or avoid being handed over to the second cell in response to the detection.

12. The apparatus of claim 11, wherein the means for detecting the occurrence of one or more conditions comprises means for detecting mobility of the UE above a threshold value.

13. The apparatus of claim 11, wherein the means for detecting the occurrence of one or more conditions comprises at least one of: means for detecting a relative timing offset between the first and second cells above a threshold value or means for detecting a relative frequency offset between the first and second cells above a threshold value.

14. The apparatus of claim 11, wherein the means for detecting the occurrence of one or more conditions comprises means for detecting a condition relating to at least one of processing or power limitations of the UE.

15. The apparatus of claim 14, wherein the means for detecting a condition relating to at least one of processing or power limitations of the UE is configured to detect the UE is handling a delay sensitive task.

16. The apparatus of claim 11, wherein the means for detecting the occurrence of one or more conditions comprises means for detecting a Radio Link Monitoring (RLM) Signal to Noise Ratio (SNR) below a threshold value.

17. The apparatus of claim 11, wherein the means for taking action comprises at least one of: means for reporting an artificially low RSRP for the second cell or means for reporting an artificially low RSRQ for the second cell.

18. The apparatus of claim 11, wherein the means for taking action comprises means for refraining from reporting measurements of the second cell.

19. The apparatus of claim 11, wherein the means for taking action comprises means for initiating a radio link failure (RLF) procedure in the second cell.

20. The apparatus of claim 11, wherein the means for taking action comprises means for entering a radio resource control (RRC) idle state in the second cell.

21. A computer-readable medium for wireless communication by a user equipment (UE), comprising instructions executable by one or more processors for:
detecting the occurrence of one or more conditions while the UE is in a region of cell range expansion (CRE) in which the UE may be handed over from a first cell of a first power class type to a second cell of a second power class type, wherein the second power class type is lower than the first power class type; and
taking action to stop being served by the second cell or avoid being handed over to the second cell in response to the detection.

22. The computer-readable medium of claim 21, wherein the instructions for detecting the occurrence of one or more conditions comprise instructions for detecting mobility of the UE above a threshold value.

23. The computer-readable medium of claim 21, wherein the instructions for detecting the occurrence of one or more conditions comprise instructions for detecting at least one of: a relative timing offset between the first and second cells above a threshold value or a relative frequency offset between the first and second cells above a threshold value.

24. The computer-readable medium of claim 21, wherein the instructions for detecting the occurrence of one or more conditions comprise instructions for detecting a condition relating to at least one of processing or power limitations of the UE.

25. The computer-readable medium of claim 21, wherein the instructions for taking action comprise instructions for entering a radio resource control (RRC) idle state in the second cell.

26. The computer-readable medium of claim 21, wherein the instructions for detecting the occurrence of one or more conditions comprise instructions for detecting a Radio Link Monitoring (RLM) Signal to Noise Ratio (SNR) below a threshold value.

27. The computer-readable medium of claim 21, wherein the instructions for taking action comprise instructions for at least one of: reporting an artificially low RSRP for the second cell or reporting an artificially low RSRQ for the second cell.

28. The computer-readable medium of claim 21, wherein the instructions for taking action comprise instructions for refraining from reporting measurements of the second cell.

29. The computer-readable medium of claim 21, wherein the instructions for taking action comprise instructions for initiating a radio link failure (RLF) procedure in the second cell.

30. An apparatus for wireless communication by a user equipment (UE), comprising:
at least one processor configured to:
detect the occurrence of one or more conditions while the UE is in a region of cell range expansion (CRE) in which the UE may be handed over from a first cell of a first power class type to a second cell of a second power class type, wherein the second power class type is lower than the first power class type; and
take action to stop being served by the second cell or avoid being handed over to the second cell in response to the detection; and
a memory coupled to the at least one processor.
